(19) United States
(12) Patent Application Publication
(10) Pub. No.: US 2007/0045566 A1
(43) Pub. Date: Mar. 1, 2007

(54) Substrate Alignment Using Linear Array Sensor

(75) Inventors: Barry McGinley, San Jose, CA (US); Lloyd Jones, San Jose, CA (US); Digby Pun, San Jose, CA (US); Robert Barnett, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Photon Dynamics, Inc., San Jose, CA (US)

(21) Appl. No.: 11/468,206

(22) Filed: Aug. 29, 2006

Related U.S. Application Data
(60) Provisional application No. 60/712,886, filed on Aug. 30, 2005.

(51) Int. Cl. G01N 23/00

(52) U.S. Cl. 250/491.1

(57) ABSTRACT

The position of a substrate's edge is detected using a substrate alignment system that includes, in part, a light source, an optical module adapted to receive a light emanating from the light source to form a multi-dimensional light beam; and an array sensor positioned at a focal plane of the optical module and oriented substantially perpendicular to the sample's edge. The substrate alignment system detects the substrate's edge position as soon as the substrate is loaded and placed within the capture range of the linear array sensor. As long as the substrate's edge position is within the capture range, the substrate does not have to be moved to determine its position relative to the tool's coordinate space. The capture range is substantially larger than the position accuracy required. The sensor array includes a multitude of sensors disposed along one or more rows.

### CROSS-REFERENCES TO RELATED APPLICATIONS

The present application claims the benefit under 35 USC 119(e) of U.S. provisional Application No. 60/712,886, filed on Aug. 30, 2005, entitled “Substrate Alignment Using Linear Array Sensor.”

### BACKGROUND OF THE INVENTION

This invention relates to large substrate alignment, and more specifically to glass substrate alignment in flat panel displays. In general, this invention may be utilized in applications requiring a means to detect the position of an edge of a sample.

During the flat panel display (FPD) manufacturing process, large glass substrates move along the production line and are transported from one machine to another. The glass substrates (hereinafter alternatively referred to as substrate, plate, glass plate, sample, or sheet) can be transported by a conveyer, or the substrates may be loaded into a cassette and then removed from the cassette by a robot, which places it in the tool and then returns it to the cassette one at a time. Usually, after the glass substrate is loaded into a particular process machinery, it needs to be aligned to a certain reference position within the machine. Because there can be a large positional variation in loading error, a conventional camera alignment method is not able to capture the glass position reliably. Instead, glass substrate alignment is typically done in two steps: first, a means of pre-alignment registers the glass position and then, the glass is moved into the final alignment or processing site. Typically, the pre-alignment must be within a 100 um window, while the final alignment requirement is within a few microns. To enable high substrate throughput in the process machine, both the time to complete the pre-alignment (coarse alignment) and the final alignment steps should be as short as possible.

One solution for alignment is to use optical point sensors to sense edge position of the glass. FIGS. 1A and 1B are simplified side and top views, respectively, of one optical point sensor assembly 100. As known in the art of sensing xy position of flat objects, three such point sensors may be typically employed in concert (two points define a line and the third defines the plane). The optical point sensor 102 senses light from the light source 120 placed directly opposite. The optical point sensor and light source are then arranged so that the glass plate plane 108 can cut the light source beam, when it is moved by the stage 112 in the x-direction (in the example of FIGS. 1A and 1B). When the glass plate blocks the light beam, the signal into the sensor is changed (fully on to off or partially on, since the glass plate will transfer some light). To correlate the change in signal which happens when the glass edge pass through the light beam, a computer 110 must capture the motor encoder position while monitoring the optical sensors' output. The motor (not shown) moves stage 112 on which substrate 108 is placed. The movement has to be slow to ensure that the computer 110 can capture and process the signals sensed by the point sensor in real time as the glass 108 edge traverses the light beam emanating from a light source 120 located on the side of the glass plate opposite the point sensor.

As known in the art of sensing xy position of flat objects, three such point sensors may be typically employed in concert (two sensors located along the y-axis for example, and a third on the x-axis). Multiple movements are usually required to obtain information for all three sensors. This method using point sensors has some disadvantages. Because the glass plate must be moved to enable searching for the edge, glass position information comes after the movement and thus increases the chance of damaging the glass during the initial blind move. Multiple slow movements are required to minimize the risk of glass damage and to ensure that a reliable data set is collected by all three sensors, resulting in an impact on the cycle time of the machine. Inaccuracy of the stage/motor encoder degrades the quality of the measurement. Additional measurement movements are required to verify the alignment accuracy because the method does not provide real time position feedback information during the alignment/correction process.

### BRIEF SUMMARY OF THE INVENTION

The position of a substrate's edge is detected using a substrate alignment system that includes, in part, a light source, an optical module adapted to receive a light emanating from the light source to form a multi-dimensional light beam; and an array sensor positioned at a focal plane of the optical module and oriented substantially perpendicular to the sample's edge. The substrate alignment system detects the substrate's edge position as soon as the substrate is loaded and placed within the capture range of the linear array sensor and without requiring the substrate to be moved. The capture range is substantially larger than the position accuracy required. The sensor array includes a multitude of sensors disposed along one or more rows and is positioned in a line perpendicular to the edge of the substrate. In one embodiment, the light source is a high-intensity LED (light emitting diode) having a Lambertian intensity profile.

The light emitted by the LED is collected and collimated by a first lens which may be an axially-symmetric, aspheric Fresnel lens that is diamond cut into a rectangular shape. For collimation to occur, the lens is positioned one focal length away from the LED source. The light collimated by the first lens is collected by a second lens that produces a cylindrical lens that focuses the light in one dimension. The resulting multi-dimensional line beam or light curtain lies parallel to the linear array sensor and the length of the two lenses. When the substrate is moved into the beam, a portion of the array sensor that is intersected by the substrate is illuminated by reflections off the substrate. The edge of the plate defines the border between the portion of the array sensor that is illuminated (by reflections off the substrate) and the portion that is not. The portion of the array sensor that is not intersected by the substrate detects only ambient light. Therefore, at the glass plate edge, there is a transition of pixel-on to pixel-off states along the linear array. More specifically, the position of the transition of pixel-on to pixel-off states along the length of the linear array correlates to the glass edge position.

A number of circuit blocks are used to read out pixels values and determine the pixel on the linear array sensor that correlates to the glass edge position. A comparator compares the voltage generated by each one of the pixels disposed in the sensor array to a threshold value to determine whether the pixel received the light reflected from the substrate or only the ambient light.

The output of the comparator is supplied to a shift register which forms, e.g., streams of 8-bit data. The threshold value is adjustable by the microcontroller in which the shift register is disposed. The microcontroller may also be used to control the output intensity of the light source. The microcontroller determines the pixel (along the linear array) associated with the substrate edge by processing the data stream. To achieve this, the microcontroller steps through the stream of data byte by byte looking for the high state (all 1's) having byte value and the low state (all 0's) having byte value 0x00. The microcontroller may look for (a) a legitimate transition on a byte boundary, (b) a legitimate transition within the byte, and (c) an indeterminate CCD readout. Correlation between the pixel position and the substrate's edge is established once a legitimate transition in the data stream is detected by the microcontroller.

Some embodiments of the substrate alignment system of the present invention include a multitude of linear array sensors that may be positioned under adjacent edges of the substrate. For example, one embodiment uses three linear array sensors, two of which are positioned along a first edges, with a third linear array sensor positioned along a second edge perpendicular to the first edge. Rotational information may be obtained by calculating arctan(x/y), where x is the pixel difference (converted to length) between the readout of two sensors positioned along the same edge, and y is the distance between to such sensors.

In accordance with another embodiment of the present invention, a two-dimensional sensor may be used. One dimension of the two-dimensional sensor may be used to detect the substrate edge. The other dimension of the two-dimensional sensor may be used to measure the height of the substrate. Substrates positioned at different heights will have reflected beams and transitions at the substrate's edge to ambient level light at different positions along the width of the two-dimensional area sensor. Hence, in addition to measuring edge location, glass-substrate height is also measured.

### BRIEF DESCRIPTION OF THE DRAWINGS

FIGS. 1A and 1B are simplified side and top views of a substrate alignment system, as known in the prior art.

FIG. 2 is a side view of a substrate alignment system, in accordance with one embodiment of the present invention.

FIG. 3 is a top view of the exemplary substrate alignment system of FIG. 2, showing the substrate being partially positioned over the beam, collimating lens, and the linear array sensor, in accordance with one embodiment of the present invention.

FIG. 4 is a top view of a substrate alignment system, in accordance with another embodiment of the present invention.

FIG. 5 shows, in part, various signal processing blocks adapted to read and process sensor voltages, in accordance with one embodiment of the present invention.

FIG. 6A shows a multitude of sensors disposed in the linear array sensor positioned to detect the substrate's edge, in accordance with one embodiment of the present invention.

FIG. 6B is a plot of the pixel's voltage as a function of the pixel's position along the linear array sensor, in accordance with one embodiment of the present invention.

FIG. 6C shows, in part, a magnification of the transition region of the plot of FIG. 6B.

FIG. 6D is an exemplary data stream generated by the microcontroller of FIG. 5.

FIG. 7 is a top view of a substrate alignment system, in accordance with another embodiment of the present invention.

FIG. 8A is a side view of a substrate alignment system using a two-dimensional sensor array, in accordance with another embodiment of the present invention.

FIG. 8B is a top view of the two-dimensional sensor array of FIG. 8A.

FIG. 8C is a top view of the substrate alignment system of FIG. 8A when the substrate is at a first height.

FIG. 8D is a top view of the substrate alignment system of FIG. 8A when the substrate is at a second height.

FIG. 8E is a top view of the substrate alignment system of FIG. 8A when the substrate is at a third height.

FIG. 9 is a side view of a substrate alignment system, in accordance with another embodiment of the present invention.

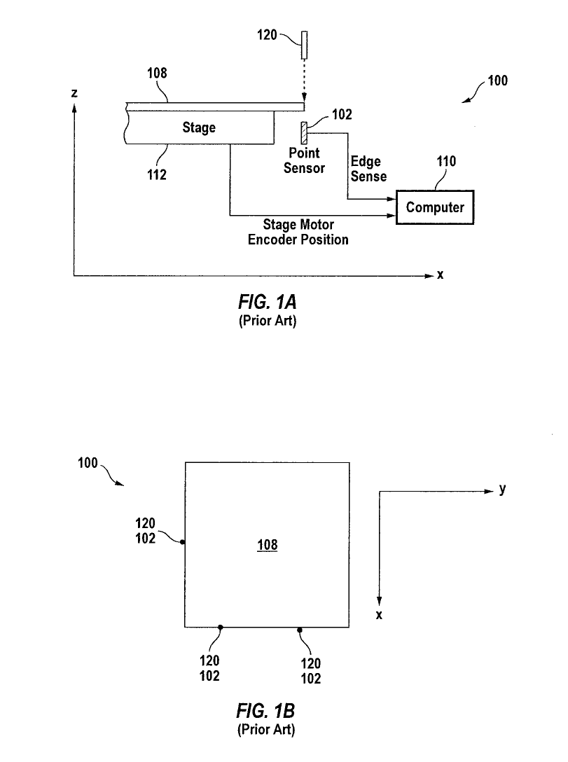

### DETAILED DESCRIPTION OF THE INVENTION

In accordance with the present invention, a linear array sensor is adapted to obtain a substrate's edge position as soon as the substrate is loaded and placed within the capture range of the linear array sensor. As long as the substrate's edge position is within the capture range of the linear array sensor, the substrate does not have to be moved to determine its position relative to the tool's coordinate space. The capture range is substantially larger than the position accuracy required. The substrate may be a glass substrate of a liquid crystal display (LCD) panel or any other substrate. In one embodiment, the sensor includes a multitude of sensors disposed along a row. The sensors may be formed using a linear array of CCDs (Charge Coupled Device), CMOS sensors, or any other linear position-sensitive optical detectors. The sensor array is positioned in a line perpendicular to the edge of the substrate. The following description is made with reference to a glass substrate, alternatively referred to as glass or plate. However, the present invention is applicable to any other substrates, glass or otherwise. In accordance with the present invention, glass edge information is obtained without glass movement after being placed within the capture range of the linear array sensor. This substantially speeds up the alignment process.

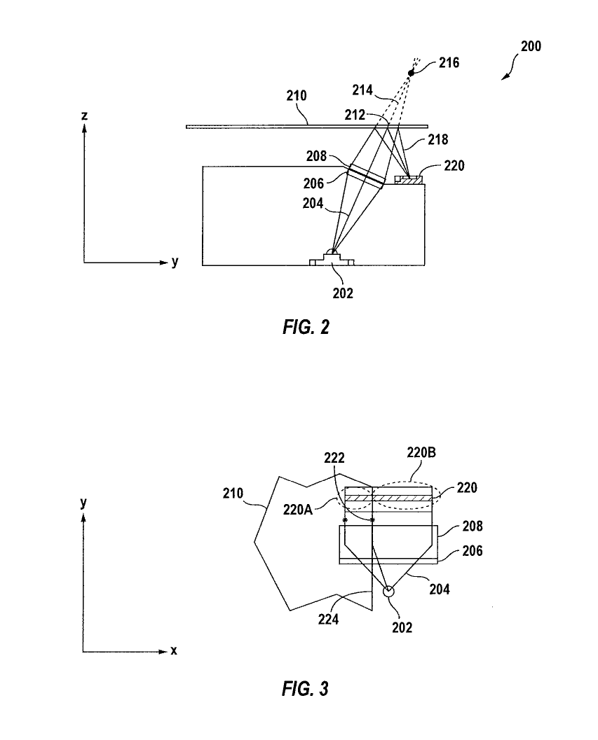

FIG. 2 is a side view of a substrate alignment system 200, in accordance with one embodiment of the present invention, showing the positional relationships of light source 202, lenses 206, 208, linear array sensor (LAS) 220 and glass 210. Light is produced by light source 202. In one embodiment, this source can be a high-intensity LED (light emitting diode) having a Lambertian intensity profile. The use of a light source with a large angle Lambertian profile (large beam divergence) relaxes alignment requirements between the source and the lenses 206, 208. In particular, the light source with a large angle Lambertian profile may be mounted on a printed circuit board without the need of having the light source pointed in the direction of lenses 206 and 208. In addition, the large angle Lambertian profile allows such a light source to illuminate the large collection angle of lens 206 without significant intensity falloff.

Light emitted by the LED is collected and collimated by lens 206, which may be an axially-symmetric, aspheric Fresnel lens that is diamond cut into a rectangular shape. For collimation to occur, the lens 206 is positioned one focal length away from the LED source. Light collimated by lens 206 is collected by lens 208, another Fresnel lens with the same rectangular dimensions as lens 206. The Fresnel grooves of lens 208 are shaped so as to produce a cylindrical lens that focuses light in one dimension, as shown in FIGS. 2 and 3. Although in the above exemplary embodiment, lenses 206 and 208 are described as being Fresnel lenses having minimize weight and size, it is understood that other optical lenses can be used.

The arrangement of the Lambertian source 202 with the lenses 206 and 208, as described above, results in a focused line source, as directed along the axis through point 216, if no plate 210 were present. The dashed ray trace 214 illustrates the focusing. The placement of the source and lenses positions the resulting line beam (216 in FIG. 2) above the linear array sensor (LAS) 220, if no plate 210 were present. FIG. 3 is a top view of the exemplary substrate alignment 200 system of FIG. 2 in which substrate 210 is shown as partially intersecting the beam, and partly overlapping lens 206, 208 and the linear array sensor 220.

Referring concurrently to FIGS. 2 and 3, the resulting multi-dimensional line beam or light curtain lies parallel to the LAS 220 and the length of the lenses 206 and 208 in the x-direction. When the plate 210 is moved into the beam in the x direction as shown in FIG. 2, the rays of light are reflected off plate 210 at location 212 and are focused to a line at linear array sensor 220. Only the portion of the LAS 220 that is intersected by the plate is illuminated by reflections off the plate. The edge of the plate defines the border between the portion of the LAS 220 that is illuminated (by reflections off the plate) and the portion that is not (the light continues beyond the plate). In FIG. 2, the light that is reflected into the LAS 220 by the presence of the plate 210 is illustrated as solid ray trace lines 218, and the light that is not intercepted by the plate and continues beyond the plate is illustrated by dotted ray trace lines 214. The portion of the LAS that is not intersected by the plate detects only ambient light.

The sensors, e.g., CCD pixels, that are covered by the glass plate, identified in FIG. 3 using perimeter line 220a, receive light reflected by the glass plate 210, and the remaining pixels, identified in FIG. 3 using perimeter line 220b, detect only the ambient light. Therefore, at the glass plate edge, there is a transition of pixel-on to pixel-off states along the linear array. More specifically, the position of the transition of pixel-on to pixel-off states along the length of the linear array correlates to the glass edge position.

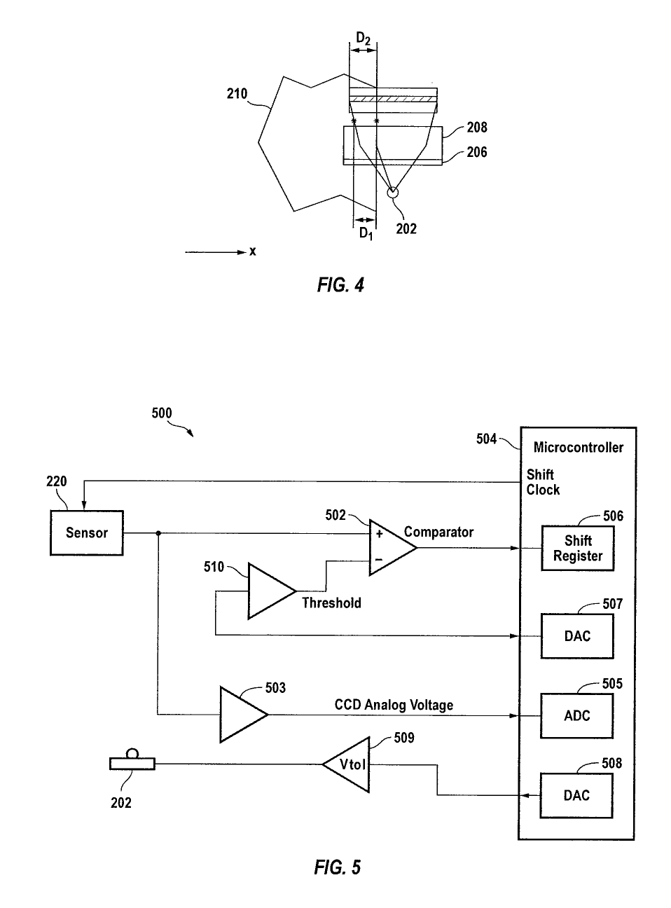

In the embodiment of the invention shown in FIGS. 2 and 3, light leaving the cylindrical lens 208 is collimated in one dimension (effectively, the y direction) and focused in the other dimension (effectively, the z direction). However, in accordance with other embodiments of this invention, substrate alignment can also be implemented with light diverging rather than being collimated, as shown in FIG. 4. In such embodiments, a movement D₁ of the plate 210 edge in the x direction is detected as a larger movement D₂ along the LAS. The resolution of the LAS is enhanced by the use of diverging light, although the full range over which the plate edge can be detected is reduced.

FIG. 5 illustrates various signal processing blocks of a system 500, in accordance with one embodiment of the present invention, adapted to read out pixels values and determine the pixel on the linear array sensor 220 that correlates to the glass edge position. During each clock cycle, the voltage signal generated by one of the pixels in sensor 220 is received by amplifier 503. In response, amplifier 503 amplifies and feeds the amplified voltage signal to analog-to-digital converter (ADC) 505 of microcontroller 504.

There are a number of methods to translate a pixel position in the linear array sensor to a corresponding physical position of the glass edge. In one embodiment, the sensor is first set up to provide a binary output (pixel-on vs. pixel-off). Then a comparator algorithm is used to determine the edge location, as described further below.

During each cycle of the clock signal, shown as being supplied by microcontroller 504 in exemplary embodiment 500, the voltage generated by one of the pixels disposed in sensor 210 is delivered to comparator 502. Comparator 502 also receives a threshold value from microcontroller 504 via amplifier 510. If the sensor value received by comparator 502 is greater than the threshold value, the comparator output is at a first logic state (e.g., high). Conversely, if the sensor value received by comparator 510 is smaller than or equal to the threshold value, the comparator output is at a second logic state (e.g., low). The comparator 502 output is fed to a shift register 506 disposed in microcontroller 504. The comparator 502 threshold is adjustable by the microcontroller through its internal digital-to-analog converter (DAC) 507 and amplifier 510. In addition, a second DAC 508, also disposed in microcontroller 504, may be used to control the output intensity of LED 202 via voltage-to-current converter 509.

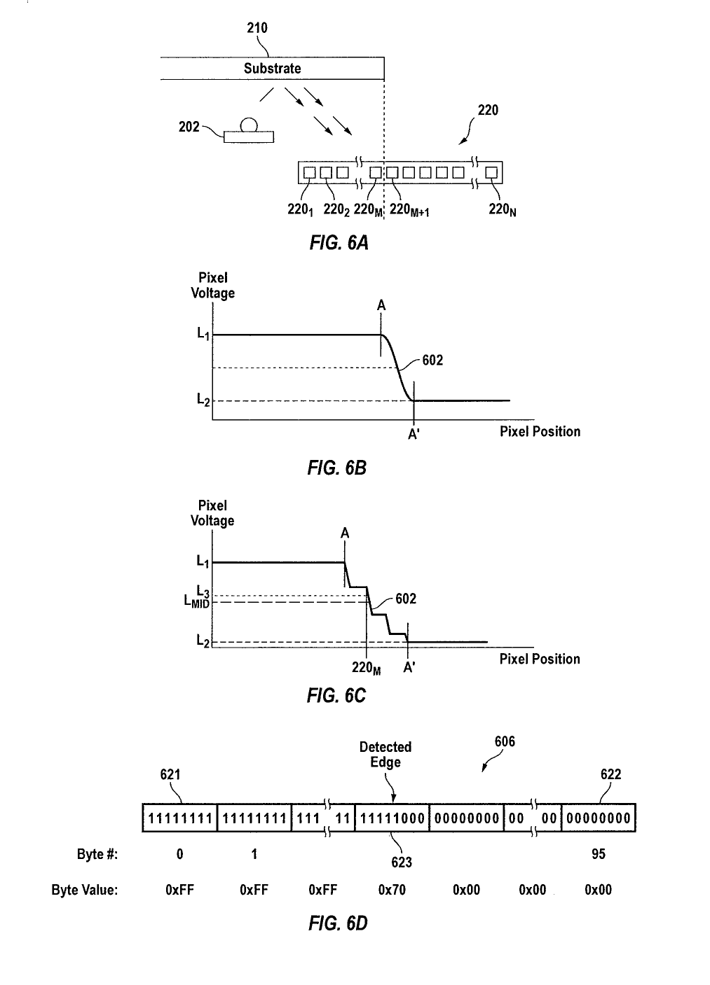

FIG. 6A shows, in part, the N pixels of linear sensor 220, a number of which, namely pixels 220 . . . . 202_{M} receive the light reflected by substrate 210, and the remaining of which pixels 220_{M+1} . . . 202_{N} are shown as only receiving the ambient light.

In one embodiment, to set up the sensor 220 for positional measurement, the linear array sensor, e.g., CCD array, is read three times. The first cycle clears or zeroes the CCD pixel voltages. The second cycle reads out the detected value of the ambient light (the light source or LED is off, “black” state). The third cycle reads the signal reflected by the glass plate (the light source or LED is on, “white” state). This third cycle uses the same integration time as that used in the ambient cycle, i.e., the second cycle, so that the detector signal caused by the ambient is the same in both cases.

The sensor 220's signal is an analog voltage value and is defined by the product of the incident light intensity and the time over which that light is integrated. FIG. 6B represents a typical output from the CCD sensor. The pixels are positioned along the x-axis, and the voltage levels detected by the pixels are shown along the y-axis. For this illustration, a smooth curve is drawn assuming that the pixels are a continuum. In one embodiment, a typical value for maximum voltage level L1 detected by a pixel is approximately 90% of full range, and a typical value for a minimum voltage level L2 (ambient) detected by a pixel is approximately 10% of full range.

Referring to FIGS. 5 and 6B concurrently, comparator 502, converts the black (i.e., ambient light only, about, for example, 10% of the full voltage range) to a first logic value. Comparator 502, converts the white (i.e., LED on, about, for example, 90% of full voltage range) to a second logic. Comparator 502 delivers the logic levels to microcontroller 504. Microcontroller 504 uses its ADC 505 to track the ambient level defining level L2 and then adjusts the integration time to keep level L2 constant. This way, if the ambient light level changes, the detector baseline signal will remain the same. In a similar fashion the microcontroller will measure the “white level” defining level L1 of the third cycle and adjusts the LED intensity (and or “on” time) so that the white level does not change as the LED ages or the reflectance of the glass sheets varies.

Thus, each pixel is effectively at one of two signal levels: ambient (pixel-off state) defining level L2; and reflected LED/light source (pixel-on state) defining level L1. Integration time and LED intensity may be adjusted to maintain the high and low voltage levels.

The glass edge shows up in the transition region 602 between lines AA′ separating white level L1 (LED light reflected) from black (ambient) baseline L2 established by the sensor output. In practice, the glass and glass edge do not reflect perfectly due to an imperfect focus of the LED image onto the detector, or due to anomalies within the glass material and/or glass edge roughness. Thus the transition region 602 may be spread over several pixels, and therefore have a non-zero slope. Because the CCD pixels' outputs are analog, and not digital, pixels at the transition between on/off states may have values between full-on and full-off.

FIG. 6C is a magnification of the transition region 602 of FIG. 6B, showing the individual pixel outputs. As illustrated in FIG. 6C, the transition from full on-state defining level L1 to ambient, off-state defining level L2 occurs over several pixels. Transition pixels such as pixel 202_{M} in FIG. 6C may have a value defined by level L3 that is less than level L1, but more than level L2. In one exemplary embodiment, levels L1 and L2 are respectively established at 90% and 10% of the full voltage level. In other embodiments, different fractions of the full voltage levels may establish levels L1 and L2. The threshold voltage of comparator 502 may be varied using microcontroller 504 to be nearly at the midpoint L_{mid} of levels L1 and L2, i.e. at nearly 50% of the full voltage value, as described further below.

The microcontroller determines a brightness factor from the range of CCD analog voltage inputs to the ADC 505. This factor is then fed back to the LED source 202 through the internal DAC 508 and voltage-to-current converter 509 to adjust the light levels to maintain pixel high/low output states at 90%/10% full range levels. With the light level appropriately adjusted and therefore the pixels high/low states defined, then the output of the ADC 505 is also fed to another internal DAC 507 which maintains the comparator threshold at 50% of full range.

In accordance with one embodiment of the present invention, the microcontroller 504 determines the pixel (along the linear array) associated with the substrate edge and that falls within the transition region 602 by processing the data stream 606 received from comparator 502, as shown in FIG. 6D. Data stream 606 is generated by microcontroller 504 which is processing data from the pixel within the linear sensor array 220. As shown in FIG. 6D, the microcontroller 504 converts the data from the comparator into the processor's native digital format 606. For example, if the microcontroller's processor is an 8-bit processor, then the data stream is divided into 8-bit segments.

The microcontroller then steps through the native digital format (bytes, in this example) and seeks the transition byte by byte looking for the high state (all 1's) having byte value 0xFF (for example, byte #0, 621) and the low state (all 0's) having byte value 0x00 (for example, byte #95, 622). The microcontroller may look for (a) a legitimate transition on a byte boundary, (b) a legitimate transition within the byte (for example, byte 623), and (c) an indeterminate CCD readout.

Once a legitimate transition is found, for example in byte 623 having value 0x70, the microcontroller provides the pixel position correlated to the detected edge to the main tool's control software. In this example, there are 768 pixels in linear array sensor 220. Therefore, if microcontroller 504 contains an 8-bit processor, it forms 96 bytes in this example. It is understood that in other embodiments, the linear array sensor may have more or fewer than this 768 pixels. Also, in other embodiments, a microcontroller may have a different sized processor, for example, 16-bit or 32-bit, and therefore convert the data into whatever the processor's native data format. Whereas processing the data without conversion to the native data format may be done, making use of the microcontroller's native data format to perform various computational operations enables full advantage of the processor's speed.

As noted previously, the glass edge or glass itself may result in imperfect reflections or non-smooth transition from high-to-low states. In these cases, it is possible that the digital stream 606 has low states interspersed among high states, rather than a series of all high states followed by a series of all low states. For example, a byte may have the form 10110100 or 01000010 rather than 11111111 or 0000000 or 11000000. Bytes comprised of high and low states interspersed within each other are considered as indeterminate readouts. Such indeterminate readouts may cause the microcontroller to perform another measurement, or it may signal to the host computer to instruct the stage to shift the glass.

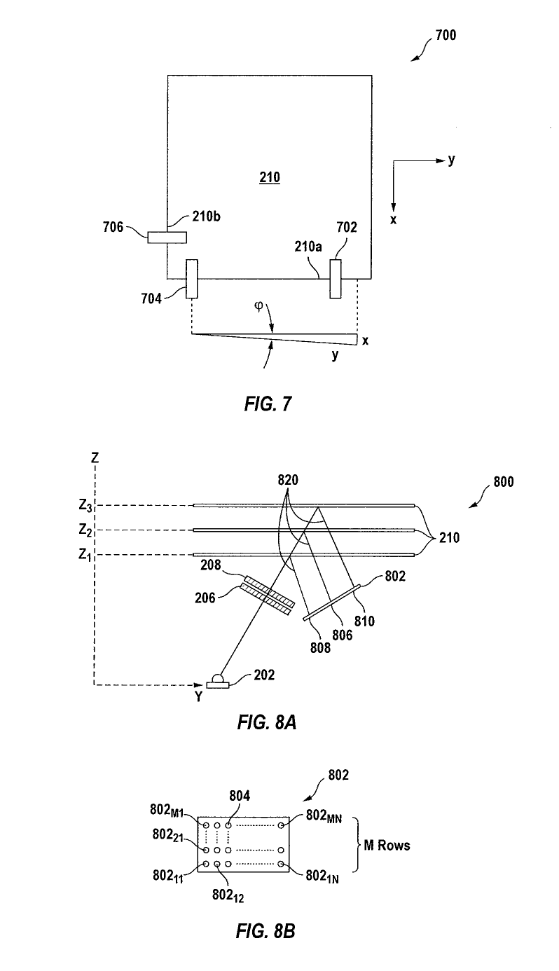

Some embodiments of the substrate alignment system of the present invention include a multitude of linear sensor assemblies, with each sensor assembly including a light source, a sensor array and associated optics, that may be positioned under adjacent edges of the substrate. FIG. 7 is a simplified view of a substrate alignment system 700, in accordance with such an embodiment. Embodiment 700 uses three linear sensor array assemblies, namely sensor array assembly 702, 704 and 706. Two of the sensor assemblies 702 and 704 are positioned along edge 210a and the third sensor assembly 706 is positioned along edge 210b that is perpendicular to edge 210a. For the axes definitions shown in FIG. 7, sensor assembly 706 will read the Y-position information. Sensor assembly 704 or an average of the values sensed by sensor assemblies 702 and 704 may provide the X position information. Rotational information (φ) may be obtained by calculating arctan(x/y), where x is the pixel difference (converted to length) between the readout of sensor assembly 702 and sensor assembly 704, and y is the distance between sensor assemblies 702 and 704. Angular resolution is highest if the two sensor assemblies, 702 and 704 are positioned with the largest distance between them possible.

For fastest response time, each sensor assembly preferably has its own microcontroller. In the example shown in FIG. 7, one of the three sensors is the master and the other two are slaves. Each sensor assembly calculates its own edge position, and the data is sent to the master sensor microcontroller when requested, typically once each measurement cycle. The master microcontroller collects the three sets of edge data and then sends the entire package of information to a host computer (not shown) when requested.

As an example, a linear array CCD of approximately 700 pixels with pixel spacing of 63 microns may be used. The focal lengths of the lenses 206 and 208 may be approximately 5 cm, and the distance from the linear array to the lower surface of the glass plate may be approximately 2.5 cm. An LED source of approximately 3 Watts may be used. A positional accuracy of the edge of the glass of +/−1 pixel may be achieved. Alignment time of approximately 1 to 2 seconds is possible, as opposed to 18 seconds using prior art methods. The use of a microcontroller to process a data stream representing the pixel binary values is very fast. Typically, for a 16 MHz processor and assuming a linear sensor of 768 pixels, the pixel that represents the edge position can be determined in less than 20 microseconds. The cost of an assembly comprised of LED, lenses, and the linear CCD sensor array is typically less than $100.

There are several advantages to using a linear array sensor for determining a substrate position. First, the use of a linear array sensor provides the substrate position information without requiring substrate movement, once the substrate position is within the capture range of the linear array sensor. This minimizes risk of damaging the substrate during the initial blind move. Second, the measurement accuracy of the substrate edge position is dependent on the pixel spacing of the selected linear sensor array and any associated algorithms, and thus the substrate edge position is independent of stage accuracy. A third advantage of the present invention is that real time position feedback information may be provided during the alignment/correction process. A fourth advantage of the edge detection arrangement of the present invention is that all the detection hardware may be located on one side of the sample (substrate), thus minimizing the complexity of hardware design and optical alignment and setup. The present invention may result in a very low profile, very compact assembly. Another advantage of the optics of this invention is that working distances may be long and adjustable, dependent on the choice of Fresnel lens focal lengths. Working distances on the order of 10 cm are possible. Further, the invention provides a non-contacting method of determining the location of an edge of a sample. Thus the advantages of the proposed arrangement for edge detection using a linear array sensor provides particular design flexibility due to its potential low cost, low profile, small package design whose position relative to the sample is not critical and whose components do not require critical alignment.

Other arrangements of the linear array sensor and optics may be possible. For example, a line generator may be used for the light source, instead of an LED and linearizing optics. A fiber optic may be used to create such a line generator. Optics other than Fresnel lenses may be used. Light sources other than LEDs may be used. Further, the selected optics may provide a two-dimensional shaped beam rather than a linear beam. Critical to the invention is the presence of a light beam of substantial length at the sample plane such that the light can be intercepted along its length by the sample plane. The beam may have breadth of any size, allowing larger edge displacements.

Other algorithms to determine glass plate position and rotation are possible. For example, with two dimensional measurement and two orthogonal linear beams and two orthogonal linear sensors, a single position-sensing device may be positioned at a corner of a glass substrate to measure the two edges intersecting at the corner. Measurement of the two edges may provide substrate rotation and absolute location of the two edges.

In accordance with another embodiment of the present invention, a two-dimensional sensor may be used. One dimension of the two-dimensional sensor may be used to detect the substrate edge as described above. The other dimension of the two-dimensional sensor may be used to measure the height of the substrate.

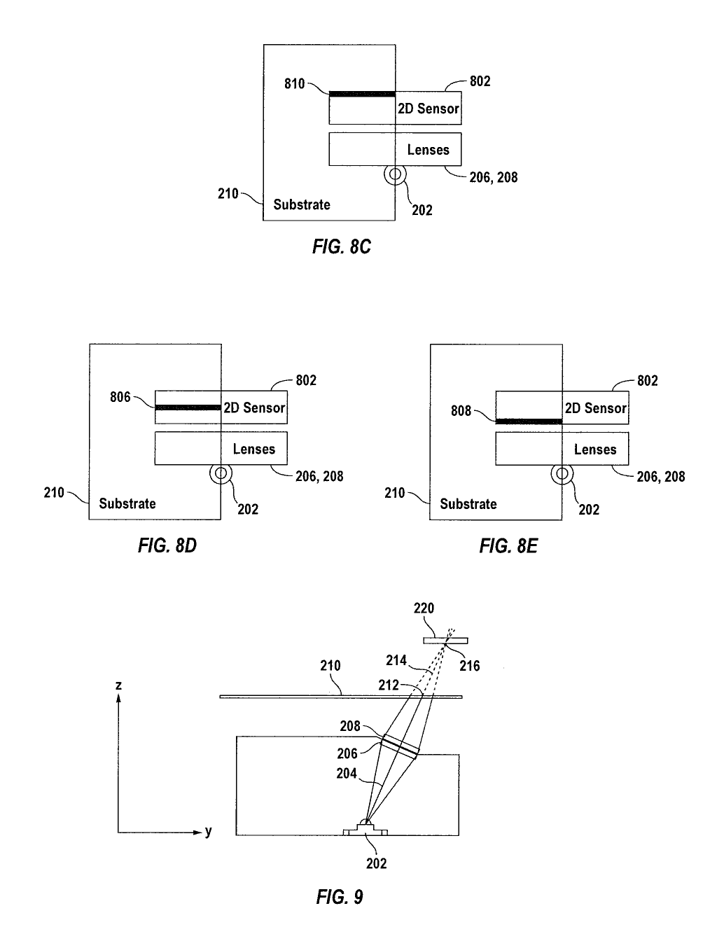

FIG. 8A is a side view of a substrate alignment system 800 that uses a two-dimensional sensor array 802, in accordance with one embodiment of the present invention. In FIG. 8A, the light source 202, which may be an LED, lenses 206, 208 and two-dimensional array sensor 802 are arranged in a manner similar to that shown in FIG. 2. Therefore, the above description for detecting the edge position of substrate 210 also applies to embodiment 800. FIG. 8B is a top view of a two-dimensional sensor array 802. Sensor array 802 is shown as having M linear arrays, each being N pixels 804 long. Substrate alignment system 800 is also adapted to detect the height of substrate 210 relative to, for example, light source 202.

FIGS. 8C, 8D and 8E are top views of the substrate alignment system 800 when substrate 210 is positioned respectively at distances Z1, Z2 and Z3 from light source 202. As seen from FIGS. 8A and 8D, the edge of the substrate when positioned at height Z2 will cut the linear light beam and the beam reflection 820 will land on the two-dimensional (area) sensor 802 at position 806. The edge of the substrate at a plane higher than height Z2, for example at height Z3, will cut the linear light beam which will reflect onto the area sensor at position 810, as shown in FIGS. 8A and 8C. Similarly, the edge of the substrate at a plane lower than height Z2, for example, at height Z1, will cut the linear light beam which will reflect on the area sensor at position 808, as shown in FIGS. 8A and 8E. The positions 808, 806, and 810 along the width of the area sensor 802 thus correlate to substrate heights Z3, Z2 and Z1 respectively. In other words, substrates positioned at different heights will have reflected beams and transitions at the substrate's edge to ambient level light at different positions along the width of the two-dimensional area sensor 802. Hence, in addition to measuring edge location, glass-substrate height is also measured. The two-dimensional sensor 802 can also be used as a means to reduce the sensitivity of the edge-sensing function to variations in working distance. Because of the greater breadth in the added dimension, the line of light is less likely to move off the sensor as variations in working distance occur.

Although the use of one, two or three sensor assemblies, with each sensor assembly including a light source, a sensor array and associated optics, to locate x, y, and rotational position of the glass plate is described herein, other arrangements and numbers of sensor assemblies are understood in view of the present invention. For example, in one embodiment, four linear sensor assemblies may be used: two at the opposing ends of one edge and two at the opposing ends of another adjacent edge of the substrate. The average reading of the two sensors along each edge establishes the centroid of the edge and the difference of the two readings divided by their average is proportional to the tangent of the substrate rotation angle. Since this angle is quite small, the difference is proportional to the angle itself. The third sensor may be used to determine the position of its associated edge, as described above, and the fourth sensor may provide redundancy. In the case where the substrate is grossly misaligned and one sensor is out of range, the other three sensors can provide sufficient information to correct the substrate position. Similarly, other algorithms and methods besides using a comparator and microcontroller to translate glass edge position from pixel position may be used.

The present invention may be used to detect the edge position of any substrate or sample, provided the sample's response to the illuminated light is distinguishable from ambient. In the flat panel case, the reflectivity from effectively bare glass is about 8%, which yields sufficient signal to distinguish from ambient to find the edge of the glass plate. The invention can be applied in the case of samples with surfaces of higher reflectivity than glass.

The present invention is also equally applicable to samples that are partially or fully absorptive. In such applications, the linear array sensor may be placed in a plane on the other side of the sample, as shown in FIG. 9. The sample blocks the light signal partially or fully and the sample edge sets the transition between pixels on and pixels off along the linear array sensor.

The present invention may be used to detect non-rectilinear samples. For example, edges of circular or irregular shapes may be detected. In the case of a circular sample, two sensor assemblies may be used to determine the center of the circular sample.

The above embodiments of the present invention are illustrative and not limiting. Various alternatives and equivalents are possible. The invention is not limited by the size, shape or the type of the substrate whose edge positions undergo detection. The invention is not limited by the number of sensors used in the array sensor, nor is it limited by the type of sensors, CCD, CMOS or otherwise, used in the array sensor. The invention is not limited to the number of sensor arrays, nor is it limited by the number of rows of sensors used in each sensor array. Other additions, subtractions or modifications are obvious in view of the present disclosure and are intended to fall within the scope of the appended claims.

What is claimed is:

1. An apparatus adapted to detect the position of an edge of a sample, the apparatus comprising:
a light source;
an optical module adapted to receive a light emanating from the light source to form a multi-dimensional light beam; and
an array sensor positioned at a focal plane of the optical module and oriented substantially perpendicular to the sample's edge.

2. The apparatus of claim 1 wherein said light source is a light emitting diode.

3. The apparatus of claim 1 wherein said optical module forms a collimated light beam.

4. The apparatus of claim 1 wherein said optical module forms a diverging light beam.

5. The apparatus of claim 1 wherein said array sensor and said light source are positioned on a same side of the sample.

6. The apparatus of claim 1 wherein said array sensor is positioned on a first side of the sample and said light source is positioned on a second side of the sample opposite the first side.

7. The apparatus of claim 1 wherein said array sensor comprises a plurality of pixels disposed along a single rows.

8. The apparatus of claim 7 wherein each of said plurality of pixels is selected from a group consisting of a charged coupled device or a CMOS device.

9. The apparatus of claim 1 wherein said light source is a point light source.

10. The apparatus of claim 1 wherein said optical module includes a light refractive optical component.

11. The apparatus of claim 1 wherein said optical module includes a light diffractive optical component.

12. The apparatus of claim 1 wherein said optical module includes a holographic component.

13. The apparatus of claim 1 wherein said optical module includes at least one Fresnel lens.

14. The apparatus of claim 1 further comprising:
a second light source;
a second optical module adapted to receive the light emanating from the second light source to form a second multi-dimensional light beam; and
a second array sensor positioned at the focal plane of the second optical module and oriented substantially perpendicular to the sample's edge and spaced away from the first array sensor.

15. The apparatus of claim 14 further comprising:
a third light source;
a third optical module adapted to receive the light emanating from the third light source to form a third multi-dimensional light beam; and
a third array sensor positioned at the focal plane of the third optical module and oriented substantially perpendicular to a second edge of the sample.

16. The apparatus of claim 1 further comprising:
a comparator adapted to generate a signal having a first state if an analog signal received from a pixel disposed in the array sensor is less than a threshold value, and to generate a signal having a second state if the analog signal received from the pixel disposed in the array sensor is greater than or equal to a threshold value.

17. The apparatus of claim 16 further comprising:
a microcontroller configured to receive the comparator's signal and vary, in response, a current supplied to the light source.

18. The apparatus of claim 17 wherein said microcontroller is further configured to change the threshold value.

19. The apparatus of claim 18 wherein said plurality of pixels of the array sensor are cleared during a first cycle.

20. The apparatus of claim 19 wherein said plurality of pixels of the array sensor receive ambient light during a second cycle.

21. The apparatus of claim 20 wherein said microcontroller is further configured to receive during a third cycle an analog voltage from each pixel disposed in the array sensor, each analog voltage being received during a different period of a clock signal, said microcontroller forming a plurality of data groups each group representing data read from a different group of the pixels disposed in the array sensor; said microcontroller further configured to identify bit transitions either within a data group or between a pair of successive data groups, and use the identified bit transitions to detect the sample's edge position, wherein a same integration time is used during the second and third cycles.

22. The apparatus of claim 21 wherein said microcontroller is further configured to clear the pixels during a fourth cycle in order to perform another measurement to detect the sample's edge if bit variations within a data group violate a predefined condition.

23. The apparatus of claim 22 wherein a violation of the predefined condition occurs if more than one transition of the bits within the data group is detected.

24. The apparatus of claim 23 wherein said microcontroller is further configured to send a signal to a host computer to move a stage carrying the sample.

25. The apparatus of claim 1 wherein said array sensor comprises a plurality of pixels disposed along a plurality of rows; said apparatus further adapted to determine a height of the sample.

26. A method of detecting the position of an edge of a sample, the method comprising:
receiving a light emanating from a light source;
forming a multi-dimensional light beam from the received light; and
orienting an array sensor at an angle substantially perpendicular to the sample's edge, said array sensor being positioned so as to collect at least a portion of the multi-dimensional light beam when said sample's edge is positioned a known distance away from a fixed point.

27. The method of claim 26 wherein said light source is a light emitting diode.

28. The method of claim 26 further comprising:
collimating the incident light to form the multi-dimensional light beam.

29. The method of claim 26 further comprising:
diverging the incident light to form the multi-dimensional light beam.

30. The method of claim 26 further comprising:
positioning said array sensor and said light source on a same side of the sample.

31. The method of claim 26 further comprising:
positioning said array sensor and said light source on opposing sides of the sample.

32. The method of claim 26 wherein said array sensor comprises a plurality of pixels disposed along a single row.

33. The method of claim 32 wherein each of said plurality of sensors is selected from a group consisting of a charged coupled device or a CMOS device.

34. The method of claim 26 wherein said light emanates from a point light source.

35. The method of claim 26 wherein said multi-dimensional light beam is formed using a light refractive optical component.

36. The method of claim 26 wherein said multi-dimensional light beam is formed using a light diffractive optical component.

37. The method of claim 26 wherein said multi-dimensional light beam is formed using a holographic component.

38. The method of claim 26 wherein said multi-dimensional light beam is formed using a Fresnel lens.

39. The method of claim 26 further comprising:
orienting a second array sensor at the angle substantially perpendicular to the sample's edge, said second array sensor being spaced away from the first array sensor.

40. The method of claim 39 further comprising:
orienting a third array sensor at an angle substantially perpendicular to a second edge of the sample, said third array sensor being positioned so as to collect at least a portion of the multi-dimensional light beam when said sample's second edge is positioned a known distance away from a second fixed point.

41. The method of claim 26 further comprising:
comparing an analog signal received from a pixel disposed in the array sensor to a threshold value to generate a first electrical signal; said first electrical signal having a first state if the analog signal received from the pixel is less than the threshold value and a second state if the analog signal received from the pixel is greater than or equal to the threshold value.

42. The method of claim 41 further comprising:
varying a current supplied to the light source in response to the generated electrical signal.

43. The method of claim 42 further comprising:
changing the threshold value.

44. The method of claim 43 further comprising:
clearing said plurality of pixels in the array sensor during a first cycle.

45. The method of claim 44 further comprising:
supplying ambient light to said plurality of pixels in the array sensor during a second cycle.

46. The method of claim 45 further comprising:
receiving, during different periods of a clock signal, an analog voltage from each pixel disposed in the one or more sensor arrays in a third cycle;
forming a plurality of data groups each group representing data read from a different group of the pixels disposed in the one or more sensor arrays;
identifying bit transitions either within a data group or between a pair of successive data groups; and
using the identified bit transitions to detect the sample's edge position, wherein a same integration time is used during second and third cycles.

47. The method of claim 46 further comprising:
clearing the pixels during a fourth cycle in order to perform another measurement to detect the sample's edge if bit variations within a data group violate a predefined condition.

48. The method of claim 47 wherein a violation of the predefined condition occurs if more than one transition of the bits within the data group is detected.

49. The method of claim 48 further comprising:
sending a signal to a host computer to move a stage carrying the sample.

50. The method 26 wherein said array sensor comprises a plurality of pixels disposed a plurality of rows; the method further comprising:
determining a height of the sample.
